(19) United States
(12) Patent Application Publication
(10) Pub. No.: US 2012/0307057 A1
(43) Pub. Date: Dec. 6, 2012

(54) CONTROL APPARATUS FOR A CABIN OF AN AIRCRAFT OR SPACECRAFT, CABIN MANAGEMENT SYSTEM AND METHOD FOR CONTROLLING A CABIN OF AN AIRCRAFT OR SPACECRAFT

(75) Inventors: Sven-Olaf Berkhahn, Ohlendorf (DE); Carsten Vogel, Hamburg (DE); Stefan Schulz, Himmelpforten (DE)

(73) Assignee: AIRBUS OPERATIONS GMBH, Hamburg (DE)

(21) Appl. No.: 13/502,505

(22) PCT Filed: Oct. 13, 2010
(86) PCT No.: PCT/EP2010/065354

§ 371 Date: Jul. 2, 2012

Related U.S. Application Data
(60) Provisional application No. 61/253,502, filed on Oct. 20, 2009.

(30) Foreign Application Priority Data
Oct. 20, 2009 (DE) 10 2009 045 837.9

(51) Int. Cl. H04N 5/232; H04N 7/18

(52) U.S. Cl. 348/144; 348/E05.042; 348/E07.085

(57) ABSTRACT

A control apparatus for a cabin of an aircraft or spacecraft, which apparatus comprises a first control device for actuating at least one camera by at least a first control signal, which control device is configured to provide the first control signal as a function of at least a second control signal for actuating at least one lighting device of the cabin.

### CROSS-REFERENCE TO RELATED APPLICATIONS

This application claims the benefit of U.S. Provisional Application No. 61/253,502, filed Oct. 20, 2009 and German Patent Application No. 10 2009 045 837.9, filed Oct 20, 2009, the entire disclosures of which are herein incorporated by reference.

### FIELD OF THE INVENTION

The present invention relates to a control apparatus for a cabin of an aircraft or spacecraft, to a cabin management system and to a method for controlling a cabin of an aircraft or spacecraft.

Although applicable to any aircraft or spacecraft, the present invention and the problem on which it is based will be described in greater detail with reference to passenger aircraft.

In a conventional aircraft cabin there are a plurality of cameras and lighting devices, such as light emitting diodes or fluorescent tubes. The cameras are for example assigned to a cabin video monitoring system (CVMS) or a cockpit door surveillance system (CDSS), which perform the function of monitoring the cabin and the region of the cockpit door by means of the cameras. The video data stream recorded by the cameras is provided to the flight attendants on a flight attendant terminal (flight attendant panel; FAP). In addition, the recorded video data stream can also be shown on a cockpit display.

The applicant has found that disturbances such as interference or alias effects occur in the recorded video stream.

The video data streams sampled by the cameras contain these disturbances owing to the pulse-width modulation of the lighting devices of the aircraft cabin.

In the A 350, the control system for the CDSS and the CVMS was integrated into the cabin management system, known as the cabin intercommunication data system (CIDS), for the first time. In addition, the CIDS also hosts the control system for the lighting of the aircraft cabin.

In the A 380, the control system for the CVMS/CDSS and the cabin lighting are separate systems, and therefore disturbance, for example interference or alias effects, in a recording by the respective camera, which disturbance is caused by actuation of the lighting device, cannot be avoided.

### SUMMARY OF THE INVENTION

An object of the present invention is therefore to overcome or at least reduce the above-mentioned drawbacks.

A control apparatus for a cabin of an aircraft or spacecraft is accordingly proposed which comprises a first control means for actuating at least one camera by means of at least a first control signal, which control means is configured to provide the first control signal as a function of at least a second control signal for actuating at least one lighting device of the cabin.

A cabin management system for an aircraft or spacecraft is also proposed which has a control apparatus as described above which can be coupled to a plurality of cameras by means of a first bus and to a plurality of lighting devices by means of a second bus.

An aircraft or spacecraft which has a cabin management system as described above is also proposed.

A method for controlling at least one camera for a cabin of an aircraft or spacecraft is also proposed which has the following steps:

providing a first control signal as a function of at least a second control signal for actuating at least one lighting device of the cabin, and
actuating the at least one camera by means of the provided at least a first control signal.

A computer program product is also proposed which on a program-controlled apparatus causes a method as described above for controlling at least one camera for a cabin of an aircraft or spacecraft to be carried out.

An advantage of the present invention is that the first control signal for controlling the cameras is generated as a function of the second control signal for actuating the lighting device. Owing to this dependency, disturbances in the recording or samplings by the camera or the cameras, which disturbances can potentially be caused by the actuation of the lighting device, can be avoided.

Advantageous embodiments and improvements of the invention are set out in the dependent claims.

According to a preferred configuration, the first control means provides the first control signal as a function of the second control signal in such a way that a disturbance in a recording by the camera, which disturbance can potentially be caused by the actuation of the lighting device, is avoided.

According to a further preferred configuration, a second control means for actuating the at least one lighting device of the cabin is provided.

According to a further preferred configuration, the first control means and the second control means are configured to provide the first control signal for adjusting the sampling rate of the at least one camera and the second control signal for adjusting a pulse-width modulation of the at least one lighting device in such a way that the sampling rate of the at least one camera and the pulse-width modulation of the at least one lighting device are synchronised.

According to a further preferred configuration, the first control means and the second control means provide the first control signal and the second control signal in such a way that the sampling rate is formed as a non-multiple of the frequency of the pulse-width modulation.

According to a further preferred configuration, the second control means forms the second control signal such that it comprises a first signal fraction and a second signal fraction. The first signal fraction is capable of adjusting a frequency of the pulse-width modulation for adjusting an amount of the light emitted by the at least one lighting device. In addition, the second signal fraction is capable of adjusting a colour vector for adjusting a colour of the light emitted by the at least one lighting device for the at least one lighting device.

According to a further preferred configuration, the respective camera has at least a filter means for compensating a non-linear colour characteristic of the camera.

According to a further preferred configuration, the second control means is configured to actuate the respective filter means of the respective camera by means of the second signal fraction of the second control signal. This second signal fraction comprises a colour compensation vector.

The light of the lighting devices, in particular the light from LEDs, can also be used for coloured light effects, known as soft light effects. The cabin having coloured lighting also affects, as set out above, the recording quality of the cameras or video cameras owing to the non-linear colour characteristic of the cameras. By using the above-mentioned filters, in particular electronic filters, a non-linear colour characteristic of this type can advantageously be compensated. This colour compensation is carried out automatically, in particular by a reference signal, the third control signal. This third control signal is thus advantageously capable of controlling the generation of the first and the second control signal.

According to a further preferred configuration, the second control means forms the second control signal such that it comprises the first signal fraction, the second signal fraction and a third signal fraction. The third signal fraction is capable of switching between a black-and-white mode and a colour mode of the respective camera.

It is advantageously possible to switch into the black-and-white mode of the camera automatically in dark environments. If the dark environment becomes brighter again owing to illumination of the lighting device, it is also possible to switch back into the colour mode automatically by means of the third signal fraction.

According to a further preferred configuration, a third means is provided which is configured to divide the cabin into different lighting regions, each comprising at least one lighting device, and independently thereof to actuate the first control means and the second control means by means of a third control signal.

The different lighting regions are for example classified as first class, business class, economy class, door region and the like. The third means is preferably configured as a cabin assignment module (CAM).

According to a further preferred configuration, the third control means is coupled to a look-up table for providing the third control signal, which look-up table stores allocations of the first control signal to the second control signal and to the respective lighting device or the respective lighting region.

According to a further preferred configuration, the first control means and the second control means provide a respective first control signal and a respective second control signal as a function of the third control signal for the corresponding lighting region.

According to a further preferred configuration, the respective lighting device has a plurality of respectively colour-specific light emitting diodes.

According to a further preferred configuration, the respective camera has a plurality of respectively colour-specific sensors.

According to a further preferred configuration, the first control means and the second control means form the first control signal and the second control signal in such a way that activation of a respective colour-specific light emitting diode triggers the activation of the corresponding colour-specific sensor.

For example, it is therefore possible to control the exposure time of the camera individually; for example a longer exposure time can be set for sensors specific to red than for sensors specific to blue.

The respective means, the first to third control means, can be implemented using hardware technology or software technology. In the case of implementation using hardware technology, the respective means can be formed as an apparatus, for example as a computer or microprocessor, device or else as part of a system, for example as a computer system. In the case of implementation using software technology, the respective means can be formed as a computer program product, as a function, as a routine, as part of a program code or as an executable object.

### BRIEF DESCRIPTION OF THE DRAWINGS

The invention will be described in further detail by way of embodiments with reference to the accompanying figures of the drawings, in which:

FIG. 1 is a schematic block diagram of a first embodiment of a control apparatus according to the invention;

FIG. 2 is a schematic block diagram of a second embodiment or a control apparatus according to the invention; and

FIG. 3 is a schematic flow chart of an embodiment of a method for controlling at least one camera for a cabin of an aircraft or spacecraft.

### DESCRIPTION OF EXEMPLARY EMBODIMENTS

In the figures, like reference numerals denote like or functionally like components, unless indicated otherwise.

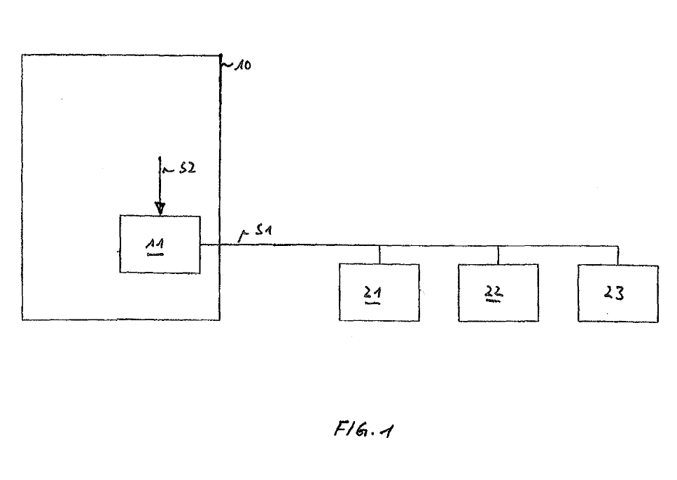

FIG. 1 is a schematic block diagram of a first embodiment of a control apparatus 10 according to the invention.

The apparatus 10 has a first control means 11 for actuating at least one camera 21-23. The control apparatus 10 is coupled to the cameras 21-23 by means of a first bus 50. The first control signal S1 is transmitted from the control apparatus 10, in particular the first control means 11, to the cameras 21-23 via the bus 50. The first control means 11 is configured to provide or to generate the first control signal S1 as a function of at least a second control signal S2 for actuating at least one lighting device 31-33 of the cabin. The first control signal S1 is also generated in such a way that a disturbance in a recording by the respective camera 21-23, which disturbance can potentially be caused by the actuation of the lighting device 31-33 or lighting devices, is avoided.

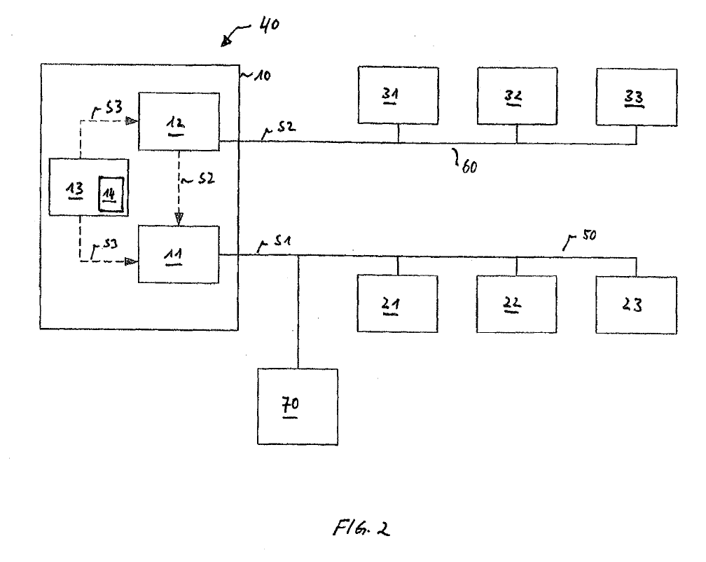

FIG. 2 is a schematic block diagram of a second embodiment of a control apparatus 10 according to the invention. The control apparatus 10 according to the invention in FIG. 2 comprises a first control means 11, a second control means 12 and a third control means 13. The control apparatus 10 is for example formed as a CIDS director. The first control means 11 is for example formed as a video controller. The second control means 12 is for example a cabin illumination application. In addition, the third control means 13 is preferably a cabin assignment module. The control apparatus 40 according to the invention can also be part of the cabin management system (CIDS).

The second embodiment according to FIG. 2 comprises all the features of the first embodiment according to FIG. 1, and to avoid repetition these will not be described again.

Thus, in particular the function of the first control means 11 will not be set out again.

The second control means 12 is capable of actuating the lighting devices 31-33 in the cabin. For this purpose, the second control means 12 is coupled to the lighting devices 31-33 by means of a second bus 60. The respective lighting device 31-33 can be formed as an LED, an arrangement of a plurality of LEDs or as fluorescent tubes. In the formation as an arrangement of a plurality of LEDs, the LEDs can also be formed as varicoloured LEDs.

The first control means 11 and the second control means 12 are preferably configured to provide the first control signal S1 for adjusting the sampling rate of the cameras 21-23 and the second control signal for adjusting the pulse-width modulation of the lighting devices 31-33 in such a way that the sampling rate and the pulse-width modulation are synchronised. In particular, the sampling rate is a non-multiple of the frequency of the pulse-width modulation.

The second control means 12 also forms the second control signal S2 such that it comprises a first signal fraction and a second signal fraction. The first signal fraction is capable of adjusting a frequency of the pulse-width modulation for adjusting an amount of light, in particular the brightness, of the light emitted by the lighting devices 31-33. By contrast, the second signal fraction is in particular capable of adjusting a colour vector for adjusting the colour of the light emitted by the lighting devices 31-33.

As set out above, the respective camera 21-23 can comprise a filter means, in particular an electronic filter, for compensating a non-linear colour characteristic. In a case of this type, the second control means 12 is preferably configured to actuate the respective filter means by means of the second control fraction of the second control signal S2. The second signal fraction then preferably comprises a colour compensation vector for compensating the above-mentioned non-linear colour characteristic.

The second control means 12 can also form the second control signal S2 such that it comprises a further signal fraction. The further signal fraction is in particular capable of switching between a black-and-white mode and a colour mode of the respective camera 21-23.

As set out above, the third control means 13, the cabin assignment module, is configured to divide the cabin into different lighting regions, each comprising a plurality of lighting devices 21-23. Independently thereof, the third control means 13 actuates the first control means 11 and the second control means 12 by means of a third control signal S3. In addition, the third control means 13 is preferably coupled to a look-up table 14 for providing this third control signal S3. The look-up table 14 can also be part of the third control means 13, as shown in FIG. 2. The look-up table 14 stores allocations of the first control signal S1 to the second control signal S2 and to the respective lighting device 31-33 or to the respective lighting region. A matching pair of first and second control signals S1 and S2 can be provided to the respective lighting device 31-33 or to the respective lighting regions. As a function of this third control signal S3, the first control means 11 and the second control means 12 provide a respective first control signal S1 and a respective second control signal S2 and transmit these via the buses 50 and 60.

In summary, the control signals S2 and S3 are provided for the first control means 11, which generates the first control signal S1 as a function thereof. The cabin video monitoring application, as a first control means 11 of the control apparatus 10 as a CIDS director, calculates the sampling rate, the colour compensation vector and the black-and-white mode switch signal for the cameras 21-23. These three elements form the first control signal S1. This first control signal S1 can be calculated individually for the respective cameras in each lighting region. The allocations as to which cameras are arranged in which lighting or cabin region are stored in the third control means 13, the cabin assignment module. The cabin video monitoring application sends this first control signal S1 to the cameras 21-23 via the first bus 50, in particular a cabin video network. The cameras 21-23 receive the first control signal S1 and set their sampling rate, the colour compensation filter and the black-and-white mode accordingly as a function thereof. The cameras 21-23 then receive the video data frames comprising the defined sampling rate, carry out data processing using the defined filter and then set the black-and-white mode accordingly. Finally, this video data stream is provided for monitoring to the flight attendant terminal 70 and a potential cockpit display.

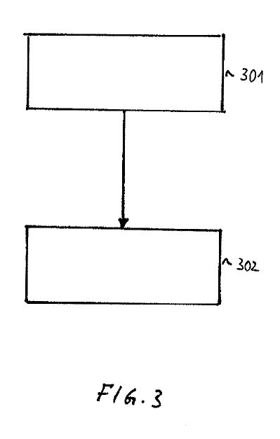

In addition, FIG. 3 is a schematic flow chart of an embodiment of the method according to the invention for controlling at least one camera 21-23 for a cabin of an aircraft or spacecraft.

The method according to FIG. 3 is described in further detail below with reference to FIG. 1.

The embodiment of the method according to FIG. 3 has the method steps 301 and 302.

### Method Step 301:

a first control signal S1 for the at least one camera 21-23 is provided as a function of at least
a second control signal S2. The second control signal S2 is capable of actuating at least one lighting device 31-33 of the cabin.

### Method Step 302:

the at least one camera 21-23 is actuated by means of the provided at least a first control signal S1.

### LIST OF REFERENCE NUMERALS

10 control apparatus, in particular CIDS director
11 first control means, in particular video controller
12 second control means, in particular illumination application
13 third control means, in particular cabin assignment module
14 look-up table
21-23 camera
31-33 lighting device
40 cabin management system
50 bus
60 bus
70 flight attendant terminal, in particular flight attendant panel
S1 first control signal
S2 second control signal
S3 third control signal
301, 302 method step

1. A control apparatus for a cabin of an aircraft or spacecraft,
which apparatus comprises a first control means for actuating at least one camera by means of at least a first control signal, which control means is configured to provide the first control signal as a function of at least a second control signal for actuating at least one lighting device of the cabin.

2. The control apparatus according to claim 1, wherein the first control means provides the first control signal as a function of the second control signal in such a way that a disturbance in a recording by the camera, which disturbance can be caused by the actuation of the lighting device is avoided.

3. The apparatus according to claim 1, wherein a second control means for actuating the at least one lighting device of the cabin is provided.

4. The apparatus according to claim 3, characterised in wherein the first control means and the second control means are configured to provide the first control signal for adjusting the sampling rate of the at least one camera and the second control signal for adjusting a pulse-width modulation of the at least one lighting device in such a way that the sampling rate of the at least one camera and the pulse-width modulation of the at least one lighting device are synchronised.

5. The apparatus according to claim 4, wherein the first control means and the second control means provide the first control signal and the second control signal in such a way that the sampling rate is formed as a non-multiple of the frequency of the pulse-width modulation.

6. The apparatus according to claim 3, wherein the second control means forms the second control signal such that it comprises a first signal fraction and a second signal fraction, the first signal fraction being capable of adjusting a frequency of the pulse-width modulation for adjusting an amount of the light emitted by the at least one lighting device, and the second signal fraction being capable of adjusting a colour vector for adjusting a colour of the light emitted by the at least one lighting device for the at least one lighting device.

7. The apparatus according to claim 1, wherein the respective camera comprises at least a filter means for compensating a non-linear colour characteristic of the camera,
the second control means being configured to actuate the respective filter means of the respective camera by means of the second signal fraction of the second control signal which signal fraction comprises a colour compensation vector.

8. The apparatus according to claim 5, wherein the second control means forms the second control signal such that is comprises the first signal fraction, the second signal fraction and a third signal fraction, the third signal fraction being capable of switching between a black-and-white mode and a colour mode of the respective camera.

9. The apparatus according to claim 1, wherein a third control means is provided which is configured to divide the cabin into different lighting regions, each comprising at least one lighting device, and independently thereof to actuate the first control means and the second control means as a function of a third control signal.

10. The apparatus according to claim 9, wherein the third control means is coupled to a look-up table for providing the third control signal, which look-up table stores allocations of the first control signal to the second control signal and to the respective lighting device or to the respective lighting region.

11. The apparatus according to claim 9, wherein the first control means and the second control means provide a respective first control signal and a respective second control signal as a function of the third control signal for the corresponding lighting region.

12. The apparatus according to claim 1 wherein the respective lighting device comprises a plurality of respectively colour-specific light emitting diodes and the respective camera comprises a plurality of respectively colour-specific sensors.

13. The apparatus according to claim 12, wherein the first control means and the second control means form the first control signal and the second control signal in such a way that the activation of a respective colour-specific light emitting diode triggers the activation of the corresponding colour-specific sensor.

14. A cabin management system for an aircraft or spacecraft, comprising:
a control apparatus according to claim 1 which can be coupled to a plurality of cameras by means of a first bus and to a plurality of lighting devices by means of a second bus.

15. A method for controlling at least one camera for a cabin of an aircraft or spacecraft, comprising the following steps:
providing a first control signal as a function of at least a second control signal for actuating at least one lighting device of the cabin; and
actuating the at least one camera by means of the provided at least a first control signal.
